(19) United States
(12) Patent Application Publication
(10) Pub. No.: US 2012/0307338 A1
(43) Pub. Date: Dec. 6, 2012

(54) ELECTROACTIVE MATERIAL

(75) Inventors: Samuel Solarski, La Madeleine (FR); Fabienne Piroux, Compiegne (FR); Gilles Bokobza, Paris (FR)

(73) Assignee: Saint-Gobain Glass France, Courbevoie (FR)

(21) Appl. No.: 13/577,388

(22) PCT Filed: Feb. 22, 2011
(86) PCT No.: PCT/FR2011/050362

§ 371 Date: Aug. 6, 2012

(30) Foreign Application Priority Data
Feb. 23, 2010 (FR) 1051292

(51) Int. Cl. B32B 17/02; B32B 5/02; B32B 5/26; G02F 1/061

(52) U.S. Cl. 359/245; 442/172; 428/221; 442/239; 442/277; 442/181; 442/318; 442/319; 442/381; 442/180

(57) ABSTRACT

An electroactive material, in the form of a self-supported layer, comprising: a matrix, which maintains the mechanical strength of the electroactive material; and an electroactive system, which is inserted in the matrix and comprises an electroactive organic compound (ea₁⁺), an electroactive organic compound (ea₂), a solubilization liquid (L), and ionic charges present as ionic salt or acid, wherein the electroactive compounds (ea₁⁺ & ea₂) and the ionic charges are in the solubilization liquid (L), wherein the matrix comprises a textile sheet (TS) or on a stack of sheets comprising the textile sheet (TS), and wherein the mineral fibers of the matrix and the solubilization liquid (L) have indices that are substantially equal, with a difference of at most 0.1. In addition, an electrically controllable device having variable optical properties, comprising the electroactive material.

The present invention relates to an electroactive material for an electrically controllable device said to have variable optical and/or energy properties, said electroactive material containing organic compounds having positive and negative redox activity respectively, to a process and a kit for manufacturing this material, to an electrically controllable device and to glazing units using such an electroactive material.

The present invention relates to an electroactive material for an electrically controllable device having variable optical/energy properties, said material being in the form of a self-supported layer and comprising or consisting of a matrix which is capable of maintaining the mechanical strength of said electroactive material and inserted in which is an electroactive system formed by:
at least one electroactive organic compound (ea₁⁺) capable of being reduced and/or of accepting electrons and cations acting as compensation charges;
at least one electroactive organic compound (ea₂) capable of being oxidized and/or of ejecting electrons and cations acting as compensation charges;
at least one of said electroactive organic compounds (ea₁⁺ and ea₂) being electrochromic in order to obtain a color contrast; and
ionic charges capable of allowing, under the action of an electric current, oxidation and reduction reactions of said electroactive organic compounds (ea₁⁺ and ea₂), which reactions are necessary in order to obtain the color contrast; said electroactive compounds (ea₁⁺ & ea₂) and said ionic charges being found within said matrix in the solubilized state, solubilized by a solubilization liquid (L), which is also capable of solubilizing the reduced and oxidized species (ea₁ & ea₂⁺) respectively associated with said electroactive compounds (ea₁⁺ & ea₂);
   said matrix furthermore being chosen to provide the percolation pathway for said ionic charges.

The solubilization liquid (L) that has solubilized said electroactive compounds and said ionic charges has sometimes been denoted hereinbelow by the expression “electroactive solution”.

The expression “cations acting as compensation charges” is understood to mean Li⁺, H⁺, etc. ions which may be inserted into or ejected from the electroactive compounds at the same time as the electrons.

The expression “electroactive organic compound capable of being reduced and/or of accepting electrons and cations acting as compensation charges” is understood to mean a compound having a negative redox activity, which may be an electrochrome with cathodic coloration or a non-electrochromic compound, then acting only as an ionic charge reservoir or a counterelectrode.

The expression “electroactive organic compound capable of being oxidized and/or of ejecting electrons and cations acting as compensation charges” is understood to mean a compound having a positive redox activity, which may be an electrochrome with anodic coloration or a non-electrochromic compound, then only acting as an ionic charge reservoir or a counterelectrode.

If it is assumed that the compound (ea₁⁺) is electrochromic (being, for example, 1,1′-diethyl-4,4′-bipyridinium diperchlorate) and that the compound (ea₂) is electrochromic (being, for example, 5,10-dihydro-5,10-dimethylphenazine) or is not electrochromic (being, for example, a ferrocene), the redox reactions that are established under the action of the electric current are the following:

ea₁⁺+e⁻≡ea₁
colored

ea₂≡ea₂⁺+e⁻
colored if electrochromic
colorless if not electrochromic

In accordance with a first prior art, the electroactive material comprises a solution or a gel containing the electroactive organic compounds (ea₁⁺ & ea₂). Mention may especially be made of the electroactive materials that are in the form of more or less viscous gels based on a polymer such as polyethylene oxide and polymethyl methacrylate, on anodic and cathodic electroactive organic compounds, at least one being electrochromic, on one or more ionic salts and on one or more solvents and additives.

In accordance with a second prior art, the electroactive material comprises a self-supported polymer matrix, inserted into which are the electroactive organic compound(s) (ea₁⁺ & ea₂) and the ionic charges, said polymer matrix containing within it a liquid (L) that solubilizes said electroactive compounds (ea₁⁺ & ea₂) and also the respectively associated reduced and oxidized species (ea₁ & ea₂⁺) and said ionic charges but that does not solubilize said self-supported polymer matrix, the latter being chosen to provide a percolation pathway for ionic charges in order to make said oxidation and reduction reactions of said electroactive organic compounds (ea₁⁺ & ea₂) possible.

Such an electroactive material is described in international PCT application WO 2009/007601 in the name of the applicant company.

In accordance with a third prior art, the electroactive material is a polymer film that is self-supported and plasticized by a liquid containing the electroactive organic compounds (ea₁⁺ & ea₂) as in patent application WO 2006/008776.

It is sought, in a general manner, to obtain electrically controllable devices having:
a good mechanical strength of the electroactive material;
coloring and bleaching rates that are as fast as possible;
a thickness of the electroactive material that is sufficient to make it possible to absorb the flatness defects of the substrates, such as toughened glass for example, and to guarantee homogeneous bleached and colored states, that is to say the same level of absorption irrespective of the zone of the device considered;
a coloring-bleaching transition that is as homogeneous as possible, namely without a coloring gradient from the edges towards the centre (halo effect) during the transient coloring or bleaching steps; and
a high contrast between the colored state and the bleached state.

The various prior art above all have drawbacks:

The electroactive gel may creep when it has been placed in the electrically controllable device (such as a glazing unit), which will lead to leaks making the device unusable. The techniques for placing the gel in the electrically controllable devices are complicated to implement, consisting of a filling (“back-filling”) optionally under vacuum, sometimes followed by a polymerization step. Furthermore, it is difficult to expel all the air during this filling operation. Finally, for large-sized glazing units, the large dimension of the equipment necessary for depositing the electroactive material or carrying out the filling operation with the gel becomes unacceptable.

In the case of the polymer film impregnated by an electroactive solution, the development of the film may prove very difficult since the film must maintain the mechanical strength of the electroactive material, have sufficient porosity to allow, after impregnation, the percolation of ionic charges through the entire thickness of the electroactive material and above all must not be solubilized nor converted to a gel in the solvent of the electroactive solution even when the electrically controllable device is subjected to temperatures ranging up to 80° C., or even higher. The polymer films corresponding to these criteria are furthermore expensive and not very durable, specifically risking being torn by handling operations during the manufacture of the device or of breaking over time, then resulting in a loss of the percolation network and in a loss of mechanical strength with formation of a gel. The polymer films that have, after impregnation, sufficient porosity to allow the percolation of ionic charges through the entire thickness of the electroactive material are generally thin, with thicknesses of less than 150-200 μm, which does not make it possible to absorb the flatness defects of the substrate which may, for example, reach several tens of microns, or even a hundred microns, in the case of toughened glass.

The self-supported and plasticized polymer film has the drawback of requiring thin thicknesses, generally of less than 100-200 μm in order to guarantee acceptable coloring and bleaching rates since the rate of diffusion of the electroactive compounds into the self-supported and plasticized polymer film is very slow. Furthermore, the self-supported polymer which is plasticized at ambient temperature is very often converted to a gel at around 80° C., which is a temperature that can be reached if the device is used outside, in the sun, which could result in leaks via flow of the electroactive material, making the device unusable under such conditions.

The present invention provides a solution to these drawbacks and proposes to use, as a matrix, at least one textile sheet, which makes it possible to have an electroactive material with a thickness of several hundreds of microns and an easy implementation of the latter via impregnation of the textile sheet(s) in the electroactive solution. The resulting self-supported electroactive material, which will be durable, and of which the thickness of several hundreds of microns will make it possible to absorb the flatness defects of the substrates, will then be able to be simply deposited on the substrate. The choice of a textile sheet furthermore offers possibilities of mixing various types of fibers, a portion of them being able to gel in the presence of the liquid for solubilization of the electroactive compounds and charges, the gel-intact fiber combination even offering improved creep resistance and making it possible to increase the tack (ability to bond) of the resulting electroactive material, this resulting in an increase of the mechanical strength of the device.

One subject of the present invention is therefore an electroactive material for an electrically controllable device having variable optical/energy properties, as defined at the very beginning of this description, said device being characterized in that the matrix is based on a textile sheet (TS) or on a stack of sheets including at least one textile sheet (TS), said textile sheet (TS) or said stack being translucent or transparent once impregnated by the liquid (L) that has solubilized said electroactive compounds (ea₁⁺ & ea₂) and the ionic charges, and being capable of retaining at least one portion of its integrity once impregnated by the liquid (L) so that the strength of said electroactive material is maintained.

In other words, the textile sheet (TS) or a textile sheet (TS) as defined above may be said to be at least partially insoluble in the liquid (L).

The textile sheet (TS) or a textile sheet (TS) may have a non-woven web or mat, woven fabric or knit fabric structure, this non-woven web or mat, this woven fabric or this knit fabric being, where necessary, coated with a binder, which may be at least partially soluble in the liquid (L) in order to form a gel.

The terms “non-woven web” and “mat” are each defined as being a film structure with fibers that are not woven and are not knitted together.

The terms “woven fabric” and “knit fabric” are defined as a matrix made of fibers and/or yarns that are respectively woven or knitted.

The woven fabrics and the knit fabrics have the advantage of a good cohesion of the yarns with each other in the absence of a binder. The binder, when it is used, makes it possible in particular to lightly gel the solubilization liquid (L), further improving the mechanical strength of the electroactive material or even the tack of the resulting electroactive material to the substrates.

Each textile sheet (TS) may be composed of one or more types of fibers or yarns, the yarns being defined as assemblies of several fibers.

The textile sheet (TS) or a textile sheet (TS) is in particular based on synthetic (artificial) fibers and/or yarns, chosen in particular from fibers and/or yarns of polyolefin such as polypropylene (PP), of polyester, of fluoropolymer such as polytetrafluoroethylene (PTFE) or polyvinylidene fluoride (PVDF), of polyamide or of polyimide; and/or based on mineral fibers such as glass fibers, and/or based on natural fibers and/or yarns, such as cotton or wool fibers and/or yarns.

In accordance with a first variant, the textile sheet (TS) or a textile sheet (TS) is based on single-component or multicomponent fibers and/or yarns, the multicomponent fibers and/or yarns being, in particular, hybrid fibers and/or yarns or fibers and/or yarns comprising a core of a chemically resistant material, capable of retaining its integrity during the impregnation by the solubilization liquid (L) in order to maintain the mechanical strength of the electroactive material, and at least one sheathing of a material soluble in the solubilization liquid (L) or capable of giving a gel during the impregnation of the textile sheet (TS) or of the stack of sheets by the impregnation liquid (L).

As examples of hybrid yarns, mention may be made of the Twintex® fibers (Owens Corning) which combine glass and polypropylene.

In accordance with a second variant, the textile sheet (TS) or a textile sheet (TS) is based on fibers and/or yarns that are insoluble in the solubilization liquid (L) and on fibers and/or yarns that are soluble in the solubilization liquid (L), the fibers and/or yarns thus solubilized having resulted in the formation of a gel. The amount of insoluble fibers and/or yarns relative to the amount of soluble fibers and/or yarns will be chosen so that the mechanical strength of the electroactive material is maintained.

Systems that combine fibers and gel will be mechanically stronger than a system based on fibers and liquid.

In accordance with a third variant, the textile sheet (TS) or a textile sheet (TS) of the stack is a textile sheet (TS) coated with a material that is soluble in the solubilization liquid (L) or that is capable of giving a gel during the impregnation of the textile sheet or of the stack of sheets by the solubilization liquid (L); mention may be made of the use of webs or woven fabrics coated with polymer such as the silicone-coated glass cloths sold by Saint-Gobain Performance Plastics under the trade mark COHRlastic®, the liquid (L) swelling or solubilizing the coating polymer.

The textile sheet (TS) or a textile sheet (TS) may have a thickness of 50 μm to 4 mm, the fibers that form it having a diameter of 50 nm to 100 μm. In the electroactive device, it will be preferred to use textile sheets having a thickness of 400 μm to 1 mm composed of fibers having a diameter between 1 μm and 20 μm. It is possible, for the matrix, to use fibers or yarns of the same diameter or of different diameters.

Mention may be made of the use of a single textile sheet (TS) or of a stack of several textile sheets (TS), the latter being identical or having different natures, and/or having different yarn diameters.

The electroactive organic compound(s) (ea₁⁺) may be chosen from bipyridiniums or viologens such as 1,1′-diethyl-4,4′-bipyridinium diperchlorate, pyraziniums, pyrimidiniums, quinoxaliniums, pyryliums, pyridiniums, tetrazoliums, verdazyls, quinones, quinodimethanes, tricyanovinylbenzenes, tetracyanoethylene, polysulfides and disulfides, and also all the electroactive polymer derivatives, such as polyviologens, of the electroactive compounds that have just been mentioned.

The electroactive organic compound(s) (ea₂) may be chosen from metallocenes, such as cobaltocenes, ferrocenes, N,N,N′,N′-tetramethylphenylenediamine (TMPD), phenothiazines such as phenothiazine, dihydrophenazines such as 5,10-dihydro-5,10-dimethyl-phenazine, reduced methylphenothiazone (MPT), methylene violet bernthsen (MVB), verdazyls, and also all the electroactive polymer derivatives of the electroactive compounds that have just been mentioned.

The ionic charges may be carried by at least one of said electroactive organic compounds and/or by at least one ionic salt and/or at least one acid solubilized in said liquid (L) and/or by said matrix.

The solubilization liquid (L) may be constituted by a solvent or a mixture of solvents and/or by at least one ionic liquid or salt that is molten at ambient temperature, said ionic liquid or molten salt or said ionic liquids or molten salts then constituting a solubilization liquid bearing ionic charges, which charges represent all or some of the ionic charges of said electroactive system.

The ionic salt(s) may be chosen in particular from lithium perchlorate, trifluoromethanesulfonate or triflate salts, trifluoromethanesulfonylimide salts and ammonium salts.

The acid(s) may be chosen in particular from sulfuric acid (H₂SO₄), triflic acid (CF₃SO₃H), phosphoric acid (H₃PO₄) and polyphosphoric acid (Hₙ₊₂PₙO₃ₙ₊₁).

The solvent(s) may be chosen in particular from sulfolane; dimethylsulfoxide; dioxane; amides such as N,N-dimethylformamide and N,N-dimethylacetamide; 1-methyl-2-pyrrolidinone; carbonates such as propylene carbonate, ethylene carbonate and butylene carbonate; ethylene glycols such as tetraglyme; alcohols such as ethanol and ethoxyethanol; ketones such as cyclopentanone and benzylacetone; lactones such as γ-butyrolactone and acetylbutyrolactone, nitriles such as acetonitrile, glutaronitrile and 3-hydroxypropionitrile; anhydrides such as acetic anhydride; ethers such as 2-methoxyethyl ether; water; phthalates; adipates; citrates; sebacates; maleates; benzoates and succinates.

The ionic liquid(s) may be chosen in particular from imidazolium salts, such as 1-ethyl-3-methylimidazolium tetrafluoroborate (emim-BF₄), 1-ethyl-3-methylimidazolium trifluoromethane sulfonate (emim-CF₃SO₃), 1-ethyl-3-methylimidazolium bis(trifluoromethyl sulfonyl)imide (emim-N(CF₃SO₂)₂ or emim-TSFI) and 1-butyl-3-methylimidazolium bis(trifluoro-methylsulfonyl)imide (bmim-N(CF₃SO₂)₂ or bmim-TSFI).

The concentration of the ionic salt(s) and/or of the acid(s) in the solvent or the mixture of solvents is especially less than or equal to 5 mol/l, preferably less than or equal to 2 mol/l, more preferably still less than or equal to 1 mol/l.

The or each solvent may be chosen from those having a boiling point at least equal to 70° C., preferably at least equal to 150° C.

The solubilization liquid (L) may also contain, in addition, at least one thickener, which will be solubilized in said liquid (L) so as to form a gel.

The thickener may especially be chosen from:
homopolymers or copolymers that do not comprise ionic charges, in which case these charges are carried by at least one aforementioned electroactive organic compound and/or by at least one ionic salt or solubilized acid and/or by at least one ionic liquid or molten salt;
homopolymers or copolymers comprising ionic charges, in which case supplementary charges that make it possible to increase the percolation rate may be carried by at least one aforementioned electroactive organic compound and/or by at least one ionic salt or solubilized acid and/or by at least one ionic liquid or molten salt; and
blends of at least one homopolymer or copolymer that does not carry ionic charges and of at least one homopolymer or copolymer comprising ionic charges, in which case supplementary charges that make it possible to increase the percolation rate may be carried by at least one aforementioned electroactive organic compound and/or by at least one ionic salt or solubilized acid and/or by at least one ionic liquid or molten salt.

The thickener may also be chosen from ethylene copolymers, vinyl acetate copolymers, ethylene/vinyl acetate copolymers (EVAs), polyurethanes (PUs), polyvinyl butyral (PVB), polyimides (PIs), polyamides (PAs), polystyrene (PS), polyvinylidene fluoride (PVDF), polyetherketones (PEKs), polyetheretherketones (PEEKs), epichlorohydrin copolymers, polyolefins, polyethylene oxide (POE), polyacrylates, polymethyl methacrylate (PMMA) and silicones, or the derivatives thereof or the monomers thereof or else the prepolymers thereof.

The thickener may also be chosen from polyelectrolytes and especially sulfonated polymers which have undergone an exchange of the H⁺ ions of the SO₃H groups with the ions of the desired ionic charges. The sulfonated polymers are especially chosen from sulfonated copolymers of tetrafluoroethylene, sulfonated polystyrenes (PSSs), copolymers of sulfonated polystyrene, poly(2-acrylamido-2-methyl-1-propanesulfonic acid) (PAMPS), sulfonated polyetheretherketones (PEEKs) and sulfonated polyimides.

The matrix may also be formed by a stack of sheets, which comprises, besides the textile sheet(s) (TS) that are at least partially insoluble in the liquid (L), at least one non-textile sheet (NTS) in which the solubilization liquid (L) has penetrated to the core in order to swell it or solubilize it, and/or at least one textile sheet (TS′) that is soluble in the liquid (L).

A “non-textile sheet” is defined as being a polymer sheet without a fibrous matrix.

The polymer constituting at least one polymer sheet of the matrix as defined in the preceding paragraph may be a homopolymer or copolymer that is in the form of a film that is non-porous but capable of swelling in said liquid, or that is in the form of a porous film, said porous film optionally being capable of swelling in the liquid comprising ionic charges and the porosity of which after swelling is chosen in order to allow the percolation of ionic charges in the thickness of the liquid-impregnated film. The polymer constituting at least one sheet may also be soluble in said liquid (L).

The polymer constituting at least one polymer sheet may also be chosen from:
homopolymers or copolymers that do not comprise ionic charges, in which case these charges are carried by at least one aforementioned electroactive organic compound and/or by at least one ionic salt or solubilized acid and/or by at least one ionic liquid or molten salt;
homopolymers or copolymers comprising ionic charges, in which case supplementary charges that make it possible to increase the percolation rate may be carried by at least one aforementioned electroactive organic compound and/or by at least one ionic salt or solubilized acid and/or by at least one ionic liquid or molten salt; and
blends of at least one homopolymer or copolymer that does not carry ionic charges and of at least one homopolymer or copolymer comprising ionic charges, in which case supplementary charges that make it possible to increase the percolation rate may be carried by at least one aforementioned electroactive organic compound and/or by at least one ionic salt or solubilized acid and/or by at least one ionic liquid or molten salt.

The polymer(s) of a polymer sheet may be chosen from ethylene copolymers, vinyl acetate copolymers, ethylene/vinyl acetate copolymers (EVAs), polyurethanes (PUs), polyvinyl butyral (PVB), polyimides (PIs), polyamides (PAs), polystyrene (PS), polyvinylidene fluoride (PVDF), polyetherketones (PEKs), polyether-etherketones (PEEKs), epichlorohydrin copolymers, polyolefins, polyethylene oxide (POE), polyacrylates, polymethyl methacrylate (PMMA) and silicones, or the derivatives thereof or the monomers thereof or else the prepolymers thereof.

The polymer(s) of a polymer sheet may also be chosen from polyelectrolytes and especially sulfonated polymers which have undergone an exchange of the H⁺ ions of the SO₃H groups with the ions of the desired ionic charges, this ion exchange having taken place before and/or at the same time as the impregnation of the matrix, constituted by the stack of the textile sheet(s) (TS) with the polymer sheet(s), in the electroactive solution, the sulfonated polymers especially being chosen from sulfonated copolymers of tetrafluoroethylene, sulfonated polystyrenes (PSSs), copolymers of sulfonated polystyrene, poly(2-acrylamido-2-methyl-1-propanesulfonic acid) (PAMPS), sulfonated polyetheretherketones (PEEKs) and sulfonated polyimides.

Furthermore, the matrix, constituted of at least one textile sheet (TS), and the liquid (L) are advantageously chosen so that the active medium withstands a temperature corresponding to the temperature required for a subsequent lamination or calendering step, namely a temperature of at least 80° C., in particular of at least 100° C.

The materials constituting the matrix and the solubilization liquid (L) may have different indices or indices that are essentially equal. It will be preferred for the indices to be essentially equal, with a difference of at most 0.10, or even of at most 0.05, so as to reduce the haze of the device.

By way of example, the matrix is constituted by a sheet of glass fibers, for example fibers of E glass (having a theoretical index of around 1.55), and the solubilization liquid (L) is constituted by dimethylphthalate (having a theoretical index of around 1.515). According to another example, the matrix is constituted by a sheet of polyvinylidene fluoride (PVDF) fibers (PVDF having a theoretical index of around 1.42) and the solubilization liquid (L) is constituted by propylene carbonate (having a theoretical index of 1.422).

Another subject of the present invention is a process for manufacturing an electroactive material as defined previously within the context of the present invention, characterized in that the impregnation of said matrix, constituted of at least one textile sheet (TS), by the solubilization liquid (L) that has solubilized said electroactive system is carried out, and then a draining operation is carried out, where appropriate.

The immersion may be carried out for a time period from 2 minutes to 3 hours. The immersion may be carried out with heating, for example at a temperature of 40 to 80° C.

The immersion may also be carried out with the application of ultrasound to aid the penetration of the electroactive solution into the matrix.

In addition, another subject of the present invention is a kit for manufacturing the electroactive material as defined previously within the context of the present invention, characterized in that it consists of:
a matrix as defined previously within the context of the present invention, capable of maintaining the mechanical strength of the electroactive material; and
a solubilization liquid (L) of the electroactive system as defined previously within the context of the present invention, in which said electroactive system has been solubilized.

Another subject of the present invention is an electrically controllable device having variable optical/energy properties, comprising the following stack of layers:
a first substrate having a glass function (V1);
a first electronically conductive layer (TCC1) with an associated current feed;
an electroactive material;
a second electronically conductive layer (TCC2) with an associated current feed; and
a second substrate having a glass function (V2),
   characterized in that the electroactive material is as defined previously within the context of the present invention.

The substrates having a glass function are especially chosen from glass (float glass, etc.) and transparent polymers, such as polymethyl methacrylate (PMMA), polycarbonate (PC), polyethylene terephthalate (PET), polyethylene naphthoate (PEN) and cycloolefin copolymers (COCs).

Within the context of the present invention, the electronically conductive layers used are denoted by “TCC”, an abbreviation for the expression “transparent conductive coating”, one example of which is a TCO (“transparent conductive oxide”).

The electronically conductive layers may also comprise a grid or a microgrid or be in the form of a grid or a microgrid; they may also comprise an organic and/or inorganic sublayer, especially in the case of plastic substrates.

The electronically conductive layers are especially layers of metallic type, such as layers of silver, of gold, of platinum and of copper; or layers of transparent conductive oxide (TCO) type, such as layers of tin-doped indium oxide (In₂O₃:Sn or ITO), of antimony-doped indium oxide (In₂O₃:Sb), of fluorine-doped tin oxide (SnO₂:F) and of aluminum-doped zinc oxide (ZnO:Al); or multilayers of the TCO/metal/TCO type, the TCO and the metal being especially chosen from those listed above; or multilayers of the NiCr/metal/NiCr type, the metal especially being chosen from those listed above.

When the electrochromic system is intended to work in transmission, the electrically conductive materials are generally transparent oxides for which the electronic conduction has been amplified by doping, such as In₂O₃:Sn, In₂O₃:Sb, ZnO:Al or SnO₂:F. Tin-doped indium oxide (In₂O₃:Sn or ITO) is frequently used for its high electronic conductivity properties and its low light absorption. Alternatively or additionally, when the system is intended to work in reflection, one of the electrically conductive materials may be of metallic nature.

The electrically controllable device of the present invention may be configured to form:
a sunroof for a motor vehicle, that can be activated autonomously, or a side window or a rear window for a motor vehicle or a rear-view mirror;
a windshield or a portion of a windshield of a motor vehicle, of an aircraft or of a ship, a vehicle sunroof;
an aircraft window;
a glazing unit for cranes, construction site vehicles or tractors;
a display panel for displaying graphical and/or alphanumeric information;
an interior or exterior glazing unit for buildings;
a skylight;
a display cabinet or store counter;
a glazing unit for protecting an object of the painting type;
an anti-glare computer screen;
glass furniture; and
a wall for separating two rooms inside a building.

The electrically controllable device according to the invention may operate in transmission or in reflection.

The substrates may be transparent, flat or curved, clear or bulk-tinted, opaque or opacified, of polygonal shape or at least partially curved.

At least one of the substrates may incorporate another functionality such as a solar control, antireflection or self-cleaning functionality.

Another subject of the present invention is a process for manufacturing the electrically controllable device as defined above in the context of the present invention, characterized in that the various layers which form it are assembled by calendering or laminating, optionally with heating.

The present invention finally relates to a single or multiple glazing unit, characterized in that it comprises an electrically controllable device as defined above in the context of the present invention.

The various layers making up said system can be assembled as a single or multiple glazing unit.

The following examples illustrate the present invention without however limiting the scope thereof. In these examples, T_{L} denotes the light transmission, and L*, a* and b* are defined as the colorimetric values in the CIELab color space.

The “K-glass™” glass used in these examples is a glass covered with an electrically conductive layer of SnO₂:F with a sheet resistance R_{□} equal to 20.5Ω/□ (glass sold under this name by Pilkington).

### EXAMPLE 1

### Preparation of an Electrochromic Cell

glass having a layer of SnO₂:F;
electroactive material: non-woven web of glass+ferrocene+1,1′-diethyl-4,4′-bipyridinium diperchlorate+lithium perchlorate+propylene carbonate;
glass having a layer of SnO₂:F.

A solution of propylene carbonate containing 0.06 mol·L⁻¹ of ferrocene, 0.06 mol·L⁻¹ of 1,1′-diethyl-4,4′-bipyridinium diperchlorate and 0.15 mol·L⁻¹ of lithium perchlorate was prepared. The solution was stirred for 30 minutes.

A non-woven web of glass, obtained by a dry route, having a thickness of 500 μm and having fibers with a thickness of 13 μm was impregnated with this solution.

The impregnated web was extended over a “K-glass™” glass substrate on the electrically conductive layer side. Strips of double-sided adhesive were placed at the periphery, then the web was covered with a second “K-glass™” glass substrate, with the electrically conductive layer side turned toward the impregnated web. The electrochromic device thus manufactured, the active surface of which is 8×8 cm², was calendered.

The performances of this electrochromic device are given in table 1 below:

TABLE 1

| | T_{L} (%) | a* | b* |
|---|---|---|---|
| Colored state powered at 1.5 V | 0.57 | 27.37 | −42.83 |
| Bleached state at 0 V | 66.86 | −3.45 | 21.99 |

### EXAMPLE 2

### Preparation of an Electrochromic Cell

glass having a layer of SnO₂:F;
electroactive material: non-woven web of glass+ferrocene+1,1′-diethyl-4,4′-bipyridinium diperchlorate+lithium triflate+bis(2-butoxyethyl)phthalate/1-ethyl-3-methylimidazolium bis(trifluoromethylsulfonyl)imide;
glass having a layer of SnO₂:F.

A solution containing 0.03 mol·L⁻¹ of ferrocene, 0.03 mol·L⁻¹ of 1,1′-diethyl-4,4′-bipyridinium perchlorate and 0.03 mol·L⁻¹ of lithium triflate in a 20/10 mixture of bis(2-butoxyethyl)phthalate/1-ethyl-3-methylimidazolium bis(trifluoromethylsulfonyl)imide was prepared. The solution was stirred for 30 minutes.

Next, the same procedure as in example 1 was used to obtain an electrochromic device, the performances of which are given in table 2 below:

TABLE 2

| | T_{L} (%) | a* | b* |
|---|---|---|---|
| Colored state powered at 1.5 V | 17.52 | 15.6 | −26.45 |
| Bleached state at 0 V | 70.12 | −3.01 | 19.32 |

### EXAMPLE 3

### Preparation of an Electrochromic Cell

glass having a layer of SnO₂:F;
electroactive material: non-woven web of glass+ferrocene+1,1′-diethyl-4,4′-bipyridinium diperchlorate+lithium triflate+propylene carbonate;
glass having a layer of SnO₂:F.

A solution of propylene carbonate containing 0.03 mol·L⁻¹ of ferrocene, 0.03 mol·L⁻¹ of 1,1′-diethyl-4,4′-bipyridinium diperchlorate and 0.10 mol·L⁻¹ of lithium triflate was prepared. The solution was stirred for 30 minutes.

A non-woven web of glass, obtained by a dry route, having a thickness of 400 μm and having E-glass fibers with a thickness of 13 μm was impregnated with this solution.

The impregnated web was extended over a “K-glass™” glass substrate on the electrically conductive layer side. Strips of double-sided adhesive were placed at the periphery, then the web was covered with a second “K-glass™” glass substrate, with the electrically conductive layer side turned toward the impregnated web. The electrochromic device thus manufactured, the active surface of which is 29×18.5 cm², was calendered.

The performances of this electrochromic device are given in table 3 below:

TABLE 3

| | | | | | Switching |
|---|---|---|---|---|---|
| | T_{L} | L* | a* | b* | time |
| Colored state | 4.5 | 25.4 | 8.7 | −52.0 | Around 80 s |
| powered at 1.5 V | | | | | for coloring |
| Bleached state | 70.7 | 87.3 | −3.7 | 14.2 | Around 90 s |
| in short-circuit | | | | | for |
| | | | | | bleaching |

### EXAMPLE 4

### Preparation of an Electrochromic Cell

glass having a layer of SnO₂:F;
electroactive material: non-woven web of polypropylene fibers+ferrocene+1,1′-diethyl-4,4′-bipyridinium diperchlorate+lithium triflate+propylene carbonate;
glass having a layer of SnO₂:F.

A solution of propylene carbonate containing 0.03 mol·L⁻¹ of ferrocene, 0.03 mol·L⁻¹ of 1,1′-diethyl-4,4′-bipyridinium diperchlorate and 0.10 mol·L⁻¹ of lithium triflate was prepared. The solution was stirred for 30 minutes.

A non-woven web of polypropylene fibers at 45 g/m² and having a thickness of around 350 μm was impregnated by this solution.

The impregnated web was extended over a “K-glass™” glass substrate on the electrically conductive layer side. Strips of double-sided adhesive were placed at the periphery, then the web was covered with a second “K-glass™” glass substrate, with the electrically conductive layer side turned toward the impregnated web. The electrochromic device thus manufactured, the active surface of which is 8×8 cm², was calendered.

The performances of this electrochromic device are given in table 4 below:

TABLE 4

| | | | | | Switching |
|---|---|---|---|---|---|
| | T_{L} | L* | a* | b* | time |
| Colored state | 1.99 | 15.43 | 22.70 | −51.70 | Around |
| powered at | | | | | 21 s for |
| 1.5 V | | | | | coloring |
| Bleached state | 64.45 | 84.20 | −2.51 | 12.34 | Around |
| in short- | | | | | 54 s for |
| circuit | | | | | bleaching |

### EXAMPLE 5

### Choice of the Solubilization Liquid

In order to reduce the haze of the electrochromic glazing units, the electroactive material of which is based on a non-woven web of glass, samples of web from example 3 were impregnated in various liquids having a high index before being encapsulated between two glasses. Listed in table 5 below are the light transmission measurements:

Total light transmission (Minolta); and
Light transmission, diffusion and haze.

TABLE 5

| | | Measurement device | | | |
|---|---|---|---|---|---|
| | | | Haze meter | | |
| | | Minolta | Tt | | Haze |
| Liquid | Index | T_{L} (%) | (%) | Td (%) | (%) |
| Propylene | 1.422 | | 83.8 | 65.9 | 78.6 |
| carbonate | | | | | |
| Dimethylphthalate | 1.515 | 88.2 | 88.2 | 1.7 | 1.9 |
| Polyethylene | 1.528 | 88.1 | 88.4 | 8.2 | 9.3 |
| glycol dibenzoate | | | | | |
| Dipropylene | 1.528 | 88.7 | 87.9 | 9.01 | 10.3 |
| glycol | | | | | |
| dibenzonate | | | | | |
| Diethylene glycol | 1.544 | 87.5 | 87.9 | 15.30 | 17.4 |
| dibenzoate | | | | | |

1. An electroactive material, which in the form of a self-supported layer, comprising:
a matrix, which maintains the mechanical strength of the electroactive material; and
an electroactive system, which is inserted in the matrix and comprises:
an electroactive organic compound (ea₁⁺) capable of being reduced;
an electroactive organic compound (ea₂) capable of being oxidized;
a solubilization liquid (L);
and
ionic charges present as ionic salt or acid,
wherein at least one of the electroactive organic compounds (ea₁⁺ and ea₂) is electrochromic,
wherein the electroactive compounds (ea₁⁺ & ea₂) and the ionic charges are solubilized in the solubilization liquid (L),
wherein the matrix comprises a textile sheet (TS) comprising mineral fibers or a stack of sheets comprising the textile sheet (TS), and
wherein the mineral fibers of the matrix and the solubilization liquid (L) have indices that are substantially equal, with a difference of at most 0.1.

2. The electroactive material of claim 1, wherein the textile sheet (TS) is a non-woven web, a non-woven mat, a woven fabric, or a knit fabric.

3-6. (canceled)

7. The electroactive material of claim 1, wherein the solubilization liquid (L), further comprises a thickener soluble in the solubilization liquid (L) so as to form a gel.

8-9. (canceled)

10. The electroactive material of claim 1, wherein the mineral fibers of the matrix and the solubilization liquid (L) have indices that are substantially equal with a difference of at most 0.05.

11. (canceled)

12. An electrically controllable device having variable optical properties, comprising, as a stack of layers:
a first substrate having a glass function (V1);
a first electronically conductive layer (TCC1) with an associated current feed;
the electroactive material of claim 1;
a second electronically conductive layer (TCC2) with an associated current feed; and
a second substrate having a glass function (V2).

13. A single or multiple glazing unit, comprising the electrically controllable device of claim 12.

14. The electroactive material of claim 2, wherein the non-woven mat, non-woven web, woven fabric, or knit fabric is coated with a binder at least partially soluble in the solubilization liquid (L) in order to form a gel.

15. The electroactive material of claim 1, wherein the mineral fibers are glass fibers.

16. The electroactive material of claim 15, wherein the solubilization liquid (L) is dimethylphthalate, polyethylene glycol dibenzoate, or dipropylene glycol dibenzonate.

17. The electroactive material of claim 15, wherein the solubilization liquid (L) is dimethylphthalate.

18. The electroactive material of claim 15, wherein the solubilization liquid (L) is polyethylene glycol dibenzoate.

19. The electroactive material of claim 15, wherein the solubilization liquid (L) is dipropylene glycol dibenzonate.

20. An electrically controllable device having variable optical properties, comprising, as a stack of layers:
a first substrate having a glass function (V1);
a first electronically conductive layer (TCC1) with an associated current feed;
the electroactive material of claim 2;
a second electronically conductive layer (TCC2) with an associated current feed; and
a second substrate having a glass function (V2).

21. An electrically controllable device having variable optical properties, comprising, as a stack of layers:
a first substrate having a glass function (V1);
a first electronically conductive layer (TCC1) with an associated current feed;
the electroactive material of claim 7;
a second electronically conductive layer (TCC2) with an associated current feed; and
a second substrate having a glass function (V2).

22. An electrically controllable device having variable optical properties, comprising, as a stack of layers:
a first substrate having a glass function (V1);
a first electronically conductive layer (TCC1) with an associated current feed;
the electroactive material of claim 10;
a second electronically conductive layer (TCC2) with an associated current feed; and
a second substrate having a glass function (V2).

23. An electrically controllable device having variable optical properties, comprising, as a stack of layers:
a first substrate having a glass function (V1);
a first electronically conductive layer (TCC1) with an associated current feed;
the electroactive material of claim 14;
a second electronically conductive layer (TCC2) with an associated current feed; and
a second substrate having a glass function (V2).

24. An electrically controllable device having variable optical properties, comprising, as a stack of layers:
a first substrate having a glass function (V1);
a first electronically conductive layer (TCC1) with an associated current feed;
the electroactive material of claim 15;
a second electronically conductive layer (TCC2) with an associated current feed; and
a second substrate having a glass function (V2).

25. An electrically controllable device having variable optical properties, comprising, as a stack of layers:
a first substrate having a glass function (V1);
a first electronically conductive layer (TCC1) with an associated current feed;
the electroactive material of claim 16;
a second electronically conductive layer (TCC2) with an associated current feed; and
a second substrate having a glass function (V2).

26. An electrically controllable device having variable optical properties, comprising, as a stack of layers:
a first substrate having a glass function (V1);
a first electronically conductive layer (TCC1) with an associated current feed;
the electroactive material of claim 17;
a second electronically conductive layer (TCC2) with an associated current feed; and
a second substrate having a glass function (V2).

27. The electroactive material of claim 1, consisting of the matrix.
